(19) United States
(12) Patent Application Publication
(10) Pub. No.: US 2001/0006373 A1
(43) Pub. Date: Jul. 5, 2001

(54) Vehicle tracking system

(76) Inventor: Byong-Man Jeong, Suwon-city (KR)

Correspondence Address: CHRISTIE, PARKER & HALE, LLP, P.O. Box 7068, Pasadena, CA, 91109-7068, US

(21) Appl. No.: 09/752,228

(22) Filed: Dec. 29, 2000

(30) Foreign Application Priority Data
Dec. 30, 1999 (KR) 1999-66831

(51) Int. Cl. G01S 5/14

(52) U.S. Cl. 342/357.07

(57) ABSTRACT

A vehicle tracking system of the present invention includeds an impact sensor mounted on a vehicle for detecting impact, an air bag which is blown up in accordance with an impact signal from the impact sensor, a navigation device receiving GPS information from satellites and transmitting an accident signal to the satellites when receiving the impact signal from the impact sensor, and a plurality of control centers for receiving an impact signal from the satellites and for sending a tracking command signal to the satellites.

### BACKGROUND OF THE INVENTION

(a) Field of the Invention

The present invention relates to a vehicle tracking system, and in particular, to a system capable of tracking a vehicle that causes an accident away from main roads or at night.

(b) Description of the Related Art

As the amount of traffic rapidly increases, night driving or driving on secondary roads increases as people avoid traffic congestion on main roads. Traffic accidents are also likely to increase at night or in isolated places away from the main roads for the above reason. In these cases, if a vehicle hits and runs, it is difficult to track the hit-and-run vehicle and also to look for hit-and-run witnesses. Until now, there has been no way to track the hit-and-run vehicles.

### SUMMARY OF THE INVENTION

The present invention has been made in an effort to solve the above problems.

It is an object of the present invention to provide a vehicle-tracking system capable of tracking a vehicle that hits and runs, using wireless communication between the vehicle and control centers, via satellites.

To achieve the above object, a vehicle tracking system of the present invention comprises an impact sensor mounted on a vehicle for detecting impact, a navigation device receiving GPS information from satellites and transmitting an accident signal to the satellites when receiving an impact signal from the impact sensor, and a plurality of control centers for receiving an impact signal from the satellites and for sending a tracking command signal to the satellites.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram for illustrating a vehicle tracking system of the present invention; and

FIG. 2 is a flow chart for illustrating the vehicle tracking system of the present invention.

### DETAILED DESCRIPTION OF THE PREFERRED EMBODIMENTS

A preferred embodiment of the present invention will be described hereinafter with reference to the accompanying drawings.

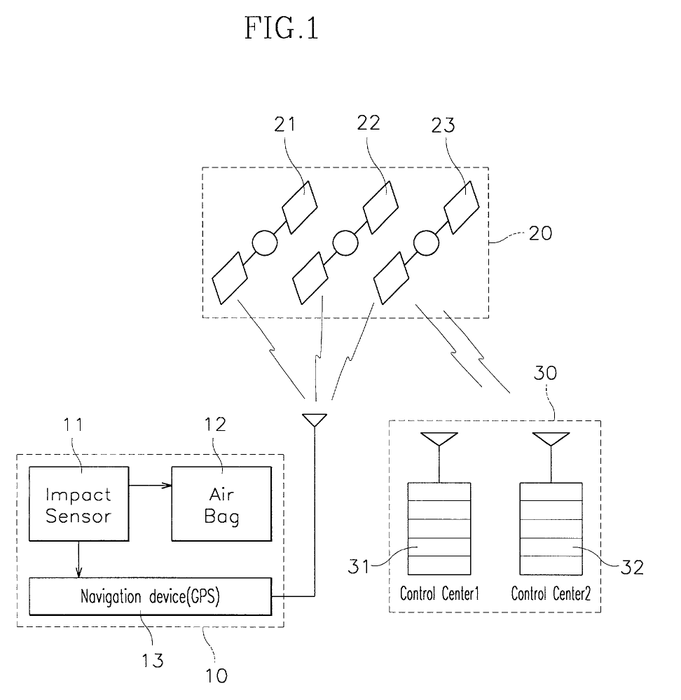

FIG. 1 is a block diagram showing a vehicle tracking system of the present invention.

The vehicle tracking system comprises three parts, i.e., a vehicle part 10, a satellite part 20, and a control part 30.

The vehicle part 10 comprises an air bag 12 and a navigation device 13 that receives an accident signal from an impact sensor 11 when the impact sensor 11 detects an impact.

If receiving the impact signal from the impact sensor 11, the air bag 12 is inflated and the navigation device 13 transmits information of a license number of the vehicle and an accident occurrence time and location to the satellite part 20, which comprises a plurality of satellites 21, 22, and 23. The navigation device 13 also acts as a receiver for receiving a vehicle's navigation information from the satellites 21, 22, and 23.

The satellites 21, 22, and 23 send the accident signal from the vehicle to the control part 30 that comprises a plurality of control centers such that control centers 31 and 32 record the accident information from the satellites 21, 22, and 23, and also tracking signals from other vehicles passing around the accident location.

The operation of the vehicle tracking system according to the preferred embodiment of the present invention will be described hereinafter.

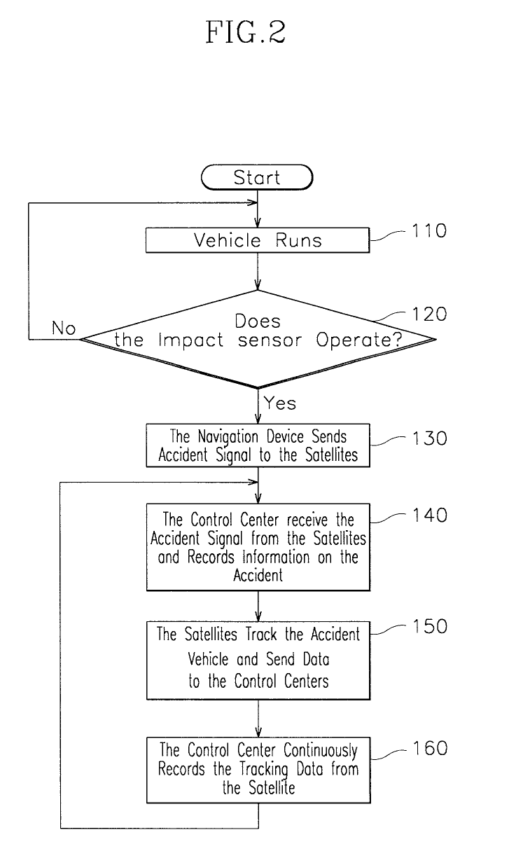

As shown in FIG. 2, while a vehicle equipped with the navigation device runs in step 110, it determines if the impact sensor 11 operates or not in step 120. If not, the navigation device communicates with the satellites 21, 22, and 23 with normal signals.

If the impact sensor 11 operates in step 120, the navigation device 13 sends an accident signal to the satellites 21, 22, and 23 in step 130, and consequently the signal is sent to the control centers 31 and 32 such that the control centers 31 and 32 analyze the impact signal and record the impact information in step 140.

Next, the control centers 31 and 32 send a tracking command signal to the satellites 21, 22, and 23 such that the satellites 21, 22, and 23 start tracking the vehicle which sent the impact signal and responsively send the tracking information to the control centers 31 and 32 in step 150.

Finally, the control centers 31 and 32 record the tracking information from the satellites 21, 22, and 23 in step 160.

Using the information recorded by the control centers 31 and 32, it is possible to search for the vehicle that caused the accident even though the vehicle leaves the scene or to find witnesses of the accident by directly tracking the vehicle or inquiring of vehicles that passed around the accident location at that time.

As described above, when a traffic accident occurs at night or in an isolated place away from the main roads and even if the assailant vehicle leaves the scene, the assailant vehicle is tracked by satellites and the tracking information is recorded at the control centers. Using the tracking information, it is possible to arrest the hit-and-run driver.

Furthermore, it is also easy to find accident witnesses using records about the vehicles that passed around the accident location at that time by inquiring of the records of the control centers.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A vehicle tracking system including a vehicle part equipped on a vehicle, a satellite part with a plurality of satellites, and a control part that wirelessly communicates with each other comprises:
an impact sensor mounted on a vehicle for detecting impact;
a navigation device receiving GPS information from satellites and transmitting an accident signal to the satellites when receiving the impact signal from the impact sensor; and
a plurality of control centers for receiving an impact signal from the satellites and for sending a tracking command signal to the satellites.

2. A vehicle tracking system of claim 1 wherein the navigation device sends information of a license number of the vehicle, location and time of an accident to the control centers via the satellites.

3. A vehicle tracking system of claim 1 wherein a control center receives information on other vehicles passing around an accident location at the time when the accident occurs.

4. A vehicle tracking system of claim 1 wherein the control center tracks an accident vehicle and records its route after receiving the accident signal from the vehicle.

5. A vehicle tracking system of claim 1 wherein the impact sensor is also associated with an air bag which is blown up in accordance with a singal from the impact sensor.
